(19) United States
(12) Patent Application Publication
(10) Pub. No.: US 2024/0355008 A1
(43) Pub. Date: Oct. 24, 2024

(54) METHOD OF ADAPTIVELY CONTROLLING RENDERED CONTENTS IN AN ELECTRONIC DEVICE

(71) Applicant: MEDIATEK INC., Hsin-Chu (TW)

(72) Inventors: Wei-Shuo Chen, Hsinchu City (TW); Tsai-Yuan Yeh, Hsinchu City (TW); Cheng-Che Chen, Hsinchu City (TW)

(73) Assignee: MEDIATEK INC., Hsin-Chu (TW)

(21) Appl. No.: 18/607,580

(22) Filed: Mar. 18, 2024

Related U.S. Application Data
(60) Provisional application No. 63/496,977, filed on Apr. 19, 2023.

(51) Int. Cl. G06T 11/00

(52) U.S. Cl. CPC G06T 11/00

(57) ABSTRACT

A method of adaptively controlling rendered contents in an electronic device is provided. After starting an APP on the electronic device, the current content status of the APP is monitored on a real-time basis. The contents of the APP are presented with an adjustable graphic quality which is adaptively adjusted based on the current content status of the APP for providing optimized balance between power consumption and user experience.

### CROSS REFERENCE TO RELATED APPLICATIONS

This application claims the benefit of U.S. Provisional Application No. 63/496,977, filed on Apr. 19, 2023. The content of the application is incorporated herein by reference.

### BACKGROUND

With the rapid development of big data, mobile computing, and internet of things (IoT), more and more mobile smart devices are emerging massively in daily life. Energy consumption of these devices has become an important consideration due to the limitation of battery capacity. One of the major sources of power drain in battery-operated mobile devices is a frame rendering and display process of user interface (UI) contents, in which power consumption depends largely on frame rendering operations per second (fps) and the quantity of UI contents to be rendered.

Typically, a prior art mobile device adopts a predetermined image rendering method for meeting user-perceived smoothness while consuming the least power possible. However, during the process of operating a mobile device, the user is not always sensitive to graphic quality. Therefore, there is a need for a method of adaptively controlling rendered contents in an electronic device for providing optimized balance between power consumption and user experience.

### SUMMARY

The present invention provides a method of adaptively controlling rendered contents in an electronic device. The method includes starting an APP on the electronic device, monitoring a current content status of the APP on a real-time basis, and presenting contents of the APP with an adjustable graphic quality which is adaptively adjusted based on the current content status of the APP.

The present invention also provides an electronic device with adaptive control of rendered contents. The electronic device includes a memory device configured to store an APP, a screen configured to present contents of the APP, and a processor. The processor is configured to monitor a current content status of the APP on a real-time basis, provide an adjustable graphic quality of the contents of the APP which is adaptively adjusted based on the current content status of the APP, and instruct the screen to present the contents of the APP with the adjustable graphic quality.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating an electronic device capable of adaptively controlling rendered contents for providing optimized balance between power consumption and user experience according to an embodiment of the present invention.

FIG. 2 is a flowchart illustrating a method of adaptively controlling rendered contents in the electronic device for providing optimized balance between power consumption and user experience according to an embodiment of the present invention.

### DETAILED DESCRIPTION

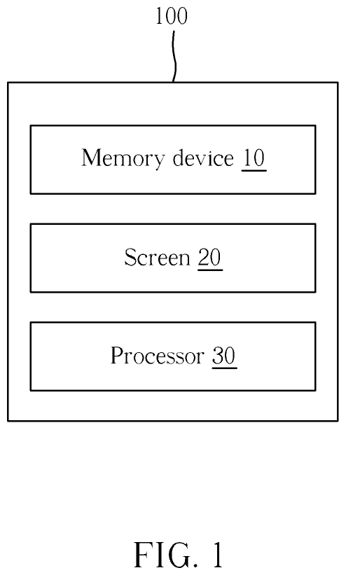

FIG. 1 is a functional block diagram illustrating an electronic device 100 capable of adaptively controlling rendered contents for providing optimized balance between power consumption and user experience according to an embodiment of the present invention. The electronic device 100 includes at least a memory device 10, a screen 20 and a processor 30. In an embodiment, the electronic device 100 may be a battery-operated mobile device, such as a smartphone, a tablet computer, a handhold game console or a wearable computer, but is not limited thereto. The memory device 10 may include a read-only memory (ROM) and/or a random-access memory (RAM) for storing the operational system, system software and various applications (APPs). The screen 20 may be a flat liquid crystal display (LCD) or an organic light-emitting diode (OLED) screen capable of providing a touch screen interface. The processor 30 is configured to control everything going on in the electronic device 100 and ensure the electronic device 100 function correctly and smoothly.

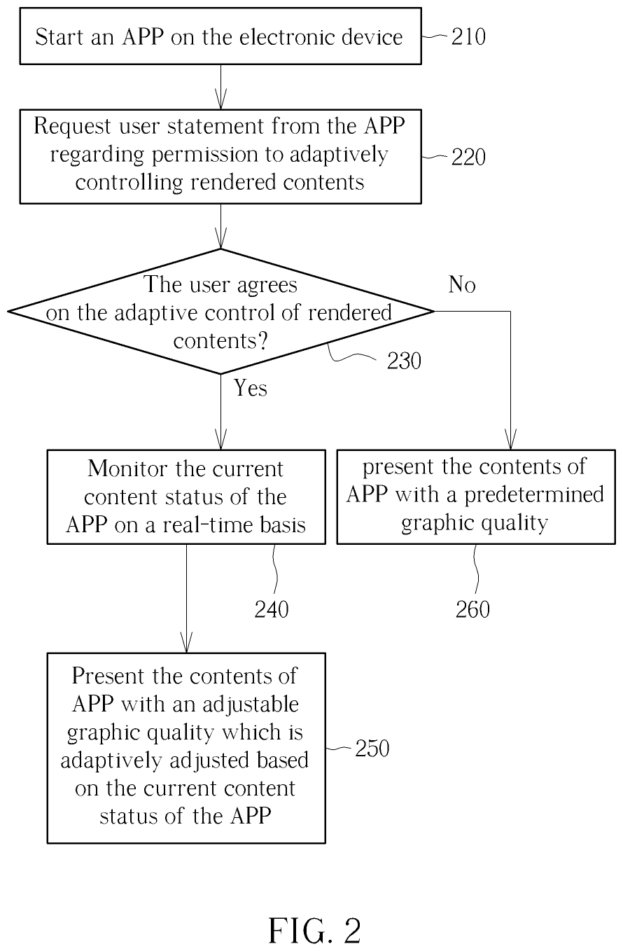

FIG. 2 is a flowchart illustrating a method of adaptively controlling rendered contents in the electronic device 100 for providing optimized balance between power consumption and user experience according to an embodiment of the present invention. The flowchart in FIG. 2 includes the following steps:
Step 210: start an APP on the electronic device 100.
Step 220: request user statement from the APP regarding permission to adaptively controlling rendered contents.
Step 230: determine whether the user agrees on the adaptive control of rendered contents; if yes, execute step 240; if no execute step 260.
Step 240: monitor the current content status of the APP on a real-time basis.
Step 250: present the contents of the APP with an adjustable graphic quality which is adaptively adjusted based on the current content status of the APP.
Step 260: present the contents of the APP with a predetermined graphic quality.

In step 210, the user of the electronic device 100 may start the APP by touching its corresponding icon on the screen 20. In an embodiment, the activated APP may be associated with a mobile game in which the actions of at least one player character are controlled by a user of the electronic device 100. In an embodiment, the activated APP associated with a mobile game typically involves moving actions of the player character at different speeds. For example, the activated APP may be associated with a racing game, an action game, a sports game or a parkour game, but is not limited thereto.

In step 220, the electronic device 100 may request the activated APP to gather user statement regarding permission to adaptively controlling its rendered contents. For example, after the user activates the APP, a selection menu may be displayed on the screen 20 before entering the game for requesting permission to adaptively controlling rendered contents for providing optimized balance between power consumption and user experience. In an embodiment, the selection menu may include a checkbox containing a YES field and a No field and may be displayed on the screen 20 of the electronic device 100, but is not limited thereto.

In step 230, the processor 30 may determine whether the user agrees on the adaptive control of rendered contents, thereby controlling the operation of the electronic device 100 accordingly in subsequent steps. If the user agrees on the adaptive control of rendered contents by selecting the YES field of the checkbox in step 220, the present method may proceed to steps 240 and 250. If the user disagrees on the adaptive control of rendered contents by selecting the NO field of the checkbox in step 220, the present method may proceed to step 260.

In step 240, the current content status of the APP is monitored on a real-time basis. In step 250, the contents of APP are presented with the adjustable graphic quality which is adaptively adjusted based on the current content status of the APP. In step 260, the contents of APP are presented with the predetermined graphic quality.

In an embodiment of executing steps 240 and 250, if the APP is associated with a racing game and the player character is not moving faster than a predetermined speed, it can be determined in step 240 that the current content status of the APP is associated with normally-paced actions of the player character, wherein any slight variation in image resolution can be easily perceived by the user. Under such circumstance, the processor 30 is configured to present the contents of the APP with a higher graphic quality in step 250. For example, the processor 30 may select a first rendering method which processes image data with a higher power state, a higher frame rate and/or a larger amount of computational resources, thereby presenting the contents of the APP with a higher graphic quality for providing the best visual experiences.

On the other hand, if the player character is moving faster than the predetermined speed, it can be determined in step 240 that the current content status of the APP is associated with fast-paced actions of the player character. When focusing on a fast-moving object, the user is relatively insensitive to any variation in image resolution. Under such circumstance, the processor 30 is configured to present the contents of APP with a lower graphic quality in step 250. For example, the processor 30 may select a second rendering method which processes image data with a lower power state, a lower frame rate and/or a smaller amount of computational resources, thereby presenting the contents of the APP with a lower graphic quality for reducing power consumption without downgrading user experience.

In another embodiment of executing steps 240 and 250, if the user is not touching the screen 20 of the electronic device 100, it can be determined in step 240 that the current content status of the APP is not associated with a touch command from the user. When focusing on the contents of the APP, any slight variation in image resolution can be easily perceived by the user. Under such circumstance, the processor 30 is configured to present the contents of APP with a higher graphic quality in step 250. For example, the processor 30 may select a first rendering method which processes image data with a higher power state, a higher frame rate and/or a larger amount of computational resources, thereby presenting the contents of the APP with a higher graphic quality for providing the best visual experiences.

On the other hand, if the user is touching the screen 20 of the electronic device 100, it can be determined in step 240 that the current content status of the APP is associated with a touch command from the user. When focusing on issuing touch commands, the user is relatively insensitive to any variation in image resolution. Under such circumstance, the processor 30 is configured to present the contents of the APP with a lower graphic quality in step 250. For example, the processor 30 may select a second rendering method which processes image data with a lower power state, a lower frame rate and/or a smaller amount of computational resources, thereby presenting the contents of the APP with a lower graphic quality for reducing power consumption without downgrading user experience.

If the user disagrees on the adaptive control of rendered contents by selecting the NO field of the checkbox in step 230, the processor 30 is configured to present the contents of APP with the predetermined graphic quality in step 260. For example, the processor 30 may select a third rendering method which processes image data with a fixed power state, a fixed frame rate and a fixed amount of computational resources, thereby presenting the contents of the APP with a fixed graphic quality per user's request.

In conclusion, the present invention provides a method of adaptively controlling rendered contents in an electronic device for providing optimized balance between power consumption and user experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of adaptively controlling rendered contents in an electronic device, comprising:
monitoring a current content status of an application (APP) on a real-time basis; and
presenting contents of the APP with an adjustable graphic quality which is adaptively adjusted based on the current content status of the APP.

2. The method of claim 1, further comprising:
monitoring the current content status of the APP for determining whether a player character in the contents of the APP is moving faster than a predetermined speed;
presenting the contents of the APP with a first graphic quality when determining that the player character in the contents of the APP is not moving faster than the predetermined speed; and
presenting the contents of the APP with a second graphic quality when determining that the player character in the contents of the APP is moving faster than the predetermined speed, wherein the first graphic quality is higher than the second graphic quality.

3. The method of claim 2, further comprising:
adopting a first rendering method for processing image data associated the contents of the APP with a first power state when determining that the player character in the contents of the APP is not moving faster than the predetermined speed; and
adopting a second rendering method for processing the image data associated the contents of the APP with a second power state when determining that the player character in the contents of the APP is moving faster than the predetermined speed, wherein the first power state is higher than the second power state.

4. The method of claim 2, further comprising:
adopting a first rendering method for processing image data associated the contents of the APP with a first frame rate when determining that the player character in the contents of the APP is not moving faster than the predetermined speed; and
adopting a second rendering method for processing the image data associated the contents of the APP with a second frame rate when determining that the player character in the contents of the APP is moving faster than the predetermined speed, wherein the first frame rate is higher than the second frame rate.

5. The method of claim 2, further comprising:
adopting a first rendering method for processing image data associated the contents of the APP with a first amount of computational resources when determining that the player character in the contents of the APP is not moving faster than the predetermined speed; and
adopting a second rendering method for processing the image data associated the contents of the APP with a second amount of computational resources when determining that the player character in the contents of the APP is moving faster than the predetermined speed, wherein the first amount of computational resources is larger than the second amount of computational resources.

6. The method of claim 1, further comprising:
monitoring the current content of the APP for determining whether a user of the electronic device is issuing a touch command;
presenting the contents of the APP with a first graphic quality when determining that the user of the electronic device is not issuing the touch command; and
presenting the contents of the APP with a second graphic quality when determining that the user of the electronic device is issuing the touch command, wherein the first graphic quality is higher than the second graphic quality.

7. The method of claim 6, further comprising:
adopting a first rendering method for processing image data associated the contents of the APP with a first power state when determining that the user of the electronic device is not issuing the touch command; and
adopting a second rendering method for processing the image data associated the contents of the APP with a second power state when determining that the user of the electronic device is not issuing the touch command, wherein the first power state is higher than the second power state.

8. The method of claim 6, further comprising:
adopting a first rendering method for processing image data associated the contents of the APP with a first frame rate when determining that the user of the electronic device is not issuing the touch command; and
adopting a second rendering method for processing the image data associated the contents of the APP with a second frame rate when determining that the user of the electronic device is not issuing the touch command, wherein the first frame rate is higher than the second frame rate.

9. The method of claim 6, further comprising:
adopting a first rendering method for processing image data associated the contents of the APP with a first amount of computational resources when determining that the user of the electronic device is not issuing the touch command; and
adopting a second rendering method for processing the image data associated the contents of the APP with a second amount of computational resources when determining that the user of the electronic device is issuing the touch command, wherein the first amount of computational resources is larger than the second amount of computational resources.

10. The method of claim 1, further comprising:
requesting a user statement from the APP regarding a permission to adaptively controlling rendered contents; and
presenting the contents of the APP with the adjustable graphic quality which is adaptively adjusted based on the current content of the APP when the user statement corresponds to the permission to adaptively controlling rendered contents.

11. The method of claim 10, further comprising:
presenting the contents of the APP with a fixed graphic quality when the user statement does not correspond to the permission to adaptively controlling rendered contents.

12. An electronic device with adaptive control of rendered contents, comprising:
a memory device configured to store an application (APP);
a screen configured to present contents of the APP; and
a processor configured to:
monitor a current content status of the APP on a real-time basis;
provide an adjustable graphic quality of the contents of the APP which is adaptively adjusted based on the current content status of the APP; and
instruct the screen to present the contents of the APP with the adjustable graphic quality.

13. The electronic device of claim 12, wherein the processor is further configured to:
monitor the current content status of the APP for determining whether a player character in the contents of the APP is moving faster than a predetermined speed;
instruct the screen to present the contents of the APP with a first graphic quality when determining that the player character in the contents of the APP is not moving faster than the predetermined speed; and
instruct the screen to present the contents of the APP with a second graphic quality when determining that the player character in the contents of the APP is moving faster than the predetermined speed, wherein the first graphic quality is higher than the second graphic quality.

14. The electronic device of claim 13, wherein the processor is further configured to:
adopt a first rendering method for processing image data associated the contents of the APP with a first power state when determining that the player character in the contents of the APP is not moving faster than the predetermined speed; and
adopt a second rendering method for processing the image data associated the contents of the APP with a second power state when determining that the player character in the contents of the APP is moving faster than the predetermined speed, wherein the first power state is higher than the second power state.

15. The electronic device of claim 13, wherein the processor is further configured to:
adopt a first rendering method for processing image data associated the contents of the APP with a first frame rate when determining that the player character in the contents of the APP is not moving faster than the predetermined speed; and
adopt a second rendering method for processing the image data associated the contents of the APP with a second frame rate when determining that the player character in the contents of the APP is moving faster than the predetermined speed, wherein the first frame rate is higher than the second frame rate.

16. The electronic device of claim 13, wherein the processor is further configured to:
adopt a first rendering method for processing image data associated the contents of the APP with a first amount of computational resources when determining that the player character in the contents of the APP is not moving faster than the predetermined speed; and
adopt a second rendering method for processing the image data associated the contents of the APP with a second amount of computational resources when determining that the player character in the contents of the APP is moving faster than the predetermined speed, wherein the first amount of computational resources is larger than the second amount of computational resources.

17. The electronic device of claim 12, wherein the processor is further configured to:
monitor the current content of the APP for determining whether a user of the electronic device is issuing a touch command;
instruct the screen to present the contents of the APP with a first graphic quality when determining that the user of the electronic device is not issuing the touch command; and
instruct the screen to present the contents of the APP with a second graphic quality when determining that the user of the electronic device is issuing the touch command, wherein the first graphic quality is higher than the second graphic quality.

18. The electronic device of claim 17, wherein the processor is further configured to:
adopt a first rendering method for processing image data associated the contents of the APP with a first power state when determining that the user of the electronic device is not issuing the touch command; and
adopt a second rendering method for processing the image data associated the contents of the APP with a second power state when determining that the user of the electronic device is not issuing the touch command, wherein the first power state is higher than the second power state.

19. The electronic device of claim 17, wherein the processor is further configured to:
adopt a first rendering method for processing image data associated the contents of the APP with a first frame rate when determining that the user of the electronic device is not issuing the touch command; and
adopt a second rendering method for processing the image data associated the contents of the APP with a second frame rate when determining that the user of the electronic device is not issuing the touch command, wherein the first frame rate is higher than the second frame rate.

20. The electronic device of claim 17, wherein the processor is further configured to:
adopt a first rendering method for processing image data associated the contents of the APP with a first amount of computational resources when determining that the user of the electronic device is not issuing the touch command; and
adopt a second rendering method for processing the image data associated the contents of the APP with a second amount of computational resources when determining that the user of the electronic device is issuing the touch command, wherein the first amount of computational resources is larger than the second amount of computational resources.
